(19) United States
(12) Patent Application Publication
(10) Pub. No.: US 2024/0177197 A1
(43) Pub. Date: May 30, 2024

(54) SYSTEM AND METHOD FOR IMPLEMENTING A PERSONALIZED SALES AGENT

(71) Applicant: B2B Rocket LLC, Sheridan, WY (US)

(72) Inventor: Shivanshu GUPTA, Sheridan, WY (US)

(21) Appl. No.: 18/434,793

(22) Filed: Feb. 6, 2024

Related U.S. Application Data
(63) Continuation-in-part of application No. 18/434,472, filed on Feb. 6, 2024.

(51) Int. Cl. G06Q 30/0251; G06Q 30/0241

(52) U.S. Cl. CPC G06Q 30/0269; G06Q 30/0277

(57) ABSTRACT

A method and system for implementing a personalized sales agent disclosed. The method includes receiving by a personalized sales agent via an interactive communication platform a conversational input from a client device associated with a prospective customer, wherein the personalized sales agent is implemented by the processing device; identifying a profile associated with the prospective customer from a content database that stores plurality of profiles of prospective customers and offerings provided by plurality of businesses; and generating a personalized sales pitch based on the profile and the conversational input, wherein the personalized sales pitch matches the profile with one or more offerings provided by at least one business; and transmitting via the interactive communication platform the personalized sales pitch to the client device for promoting sales of the at least one business.

### PRIORITY CLAIM

This patent application claims priority to U.S. Non-Provisional application Ser. No. 18/434,472, which was filed on Feb. 6, 2024, which is hereby incorporated by reference in their entirety.

### FIELD

The present disclosure related to online sales and recommendation systems and more particularly, to a system and method for implementing a personalized sales agent.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system for implementing a personalized sales agent is proposed. The system includes a memory comprising instructions; and a processing device operatively coupled to the memory, where the processing device execute the instructions to perform the following functions. The processing device to receive by a personalized sales agent via an interactive communication platform a conversational input from a client device associated with a prospective customer, wherein the personalized sales agent is implemented by the processing device; identify a profile associated with the prospective customer from a content database that stores plurality of profiles of prospective customers and offerings provided by plurality of businesses; generate a personalized sales pitch based on the profile and the conversational input, wherein the personalized sales pitch matches the profile with one or more offerings provided by at least one business; and transmit via the interactive communication platform the personalized sales pitch to the client device for promoting sales of the at least one business.

According to another embodiment of the present invention, a method for implementing a personalized email agent is disclosed. The method includes, receiving, receiving by a personalized sales agent via an interactive communication platform a conversational input from a client device associated with a prospective customer, wherein the personalized sales agent is implemented by the processing device; identifying a profile associated with the prospective customer from a content database that stores plurality of profiles of prospective customers and offerings provided by plurality of businesses; generating a personalized sales pitch based on the profile and the conversational input, wherein the personalized sales pitch matches the profile with one or more offerings provided by at least one business; and transmitting via the interactive communication platform the personalized sales pitch to the client device for promoting sales of the at least one business.

### BACKGROUND

During a physical or face-to-face interaction between two people, a first person may try to understand the other person's interests, preferences, views, personality, mood and likes before recommending something to that person. However, in an electronic environment, gaining an understanding of a person in order to generate recommendations of content likely to match the interests of a prospective customer and result in a positive engagement by the prospective customer is a difficult challenge.

In business to business (B2B) sales and marketing for any industry, it is desirable to have a personal touch while communicating with prospective customers and to provide a personalized sales pitch that can attract an attention of a prospective customer. Usually, companies provide a general sales pitch that is provided to any prospective customer or client. The general sales pitch will have information regarding the products and services of the business, but would not be personalized in terms of how those products could be useful for a prospective customer. Further, out of the whole range of products and services, the prospective customer would be interested only in a subset of products or services. In such a scenario, it becomes essential to personalize the sales pitch to each prospective customer, while highlighting only the products or services that could be of interest to the customer.

Such a sales pitch or presentation can be more effective in converting the prospective customer into a customer, and thereby improving the sales of the business. However, in order to generate personalized sales pitch that have personalized recommendations of content that match the interests of the prospective customer is a difficult challenge. Curating information pertaining to the interest of the customer, matching it with the services provided by plurality of businesses and providing personalized sales pitch is required to improve the efficiency of business to business (B2B) and business to consumer (B2C) communication.

Accordingly, there is a need for an intelligent proactive personalized sales agent or a personalized sales agent for the business that can model the market composition and target customers for the business, and use the model to generate a personalized sales pitch and presentation including personalized videos catering to the interest of the prospective customer.

Hence, a system and a method that implements such personalized sales agent for providing personalized video and sales presentation to prospective customers.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a schematic block diagram of a system for implementing a personalized sales agent for promoting sales of a business, according to an embodiment of the present invention;

FIG. 2 is a schematic block diagram of a content database of the system of FIG. 1, according to an embodiment of the present invention;

FIG. 3 is a flowchart of a method for implementing a personalized sales agent for promoting sales of a business, according to some aspects of the present invention; and

FIG. 4 is a block diagram of an embodiment of a computing device in which the modules of a system for implementing a personalized sales agent, described herein, are implemented.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figures. It should also be noted that in some alternative implementations, the functions/actions/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or a section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments of the present description provide a method and system for implementing a personalized sales agent for providing personalized sales pitch for promoting one or more businesses. The system is typically located on a cloud network and is scalable, performant and efficient in terms of digital communication and resource utilization compared to existing systems that generate sales pitches in the forms of presentations and videos. Disclosed invention helps in creation of digital content like sales pitches and presentations that consumes lesser network and computing resources.

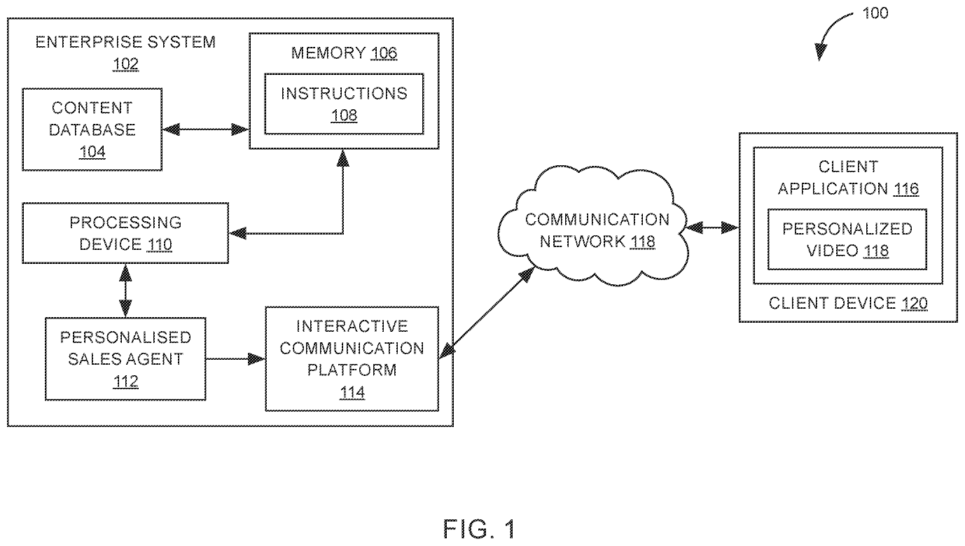

FIG. 1 is a schematic block diagram of a system (100) for implementing a personalized sales agent for promoting sales of a business, according to an embodiment of the present invention. The system (100) includes an enterprise system (102), in communication with a client device (120) over a communication network (118). The enterprise system (102) comprises a content database (104), a processing device (110), a personalized sales agent (112), a memory (106) comprising instructions (108) and an interactive communication platform (114). The processing device (110), the memory (106), the personalized sales agent (112) are communicatively coupled via one or more communication links. The communication links can be dedicated wired links or wireless links. The client device (120) is associated with a prospective customer, and has a client application (116) through which the prospective customer communicates with the personalized sales agent (112) over the interactive communication platform (114).

The processing device (110) is operatively coupled to the memory (106) to execute the instructions (108) to facilitate the personalized sales agent (112) to perform a plurality of operations. The personalized sales agent (112) communicates with the client devices (120) via the interactive communication platform (114). The interactive communication platform (116) can be a chat application, or an interactive messaging system through which the personalized sales agent (112) interacts with the client device (120). Typically, a client device (e.g. 120a) can be a prospective customer device like a mobile phone, laptop, personal digital assistant and the like which has a client application (122a) like an email client through which a consumer or a prospective customer interacts with the personalized sales agent (112).

In an embodiment, the personalized sales agent (112) is configured to perform a plurality of operations for interacting with one or more consumers for selling or facilitating marketing of products and services of an enterprise or business to which the enterprise system (102) belongs to. For example, in case the enterprise sells computer accessories, the personalized sales agent (112) can create a personalized video (118) to run on the client device (120) and that caters to the needs and likes of the prospective customer

In order achieve the aforesaid, processing device (110) is operatively coupled to the memory (106) and is configured to execute the instructions (108) to implement the personalized sales agent (112). The personalized sales agent (112) receives via the interactive communication platform (114) a conversational input from the client device (120) that is associated with the prospective customer. Typically, a client device (e.g. 120a) can be a prospective customer device like a mobile phone, laptop, personal digital assistant and the like which has a client application (122a) like a chat client through which the prospective customer interacts with the personalized sales agent (112). Basically, the prospective customer interacts with the personalized sales agent (112) via the interactive communication platform (114).

The personalized sales agent (112) identifies a profile associated with the prospective customer from the content database (104). The content database (104) stores profiles of plurality of prospective customers and offerings provided by plurality of businesses. The content database (104) comprises curates data related to a plurality of businesses, products associated with each business, categories of prospective customers, and a plurality of prospective customers, where data related to the plurality of prospective customers comprise prospective customer profile information for each prospective customer and preferences of the each prospective customer.

Further, the personalized sales agent (112) generates a personalized sales pitch based on the profile and the conversational input. The personalized sales pitch can include a personalized video (118), a sales presentation or a combination of both. The conversational input can include one or more of a text, message, email chat, video and audio information. The personalized sales pitch matches the profile with one or more offerings provided by at least one business. Further, the processing device (110) caused the personalized sales pitch to be transmitted to the client device. Further, the processing device (110) updates the content database at predefined time periods, or when conversational inputs are received. Further, the preferences of the each prospective customer is updated upon receiving one or more conversational inputs from the each prospective customer.

Typically, the processing device receives a generic video from the prospective customer along with a plurality of prospective customer related information as the conversational input. Further, a product is identified as relevant to the prospective customer based on the conversational input. The processing device further modifies the generic video into the personalized video comprising the sales pitch for the product. In an embodiment, the processing device (110) is also configured to create a personalized landing page for a prospective customer visiting the website associated with at least one company that is selling the product.

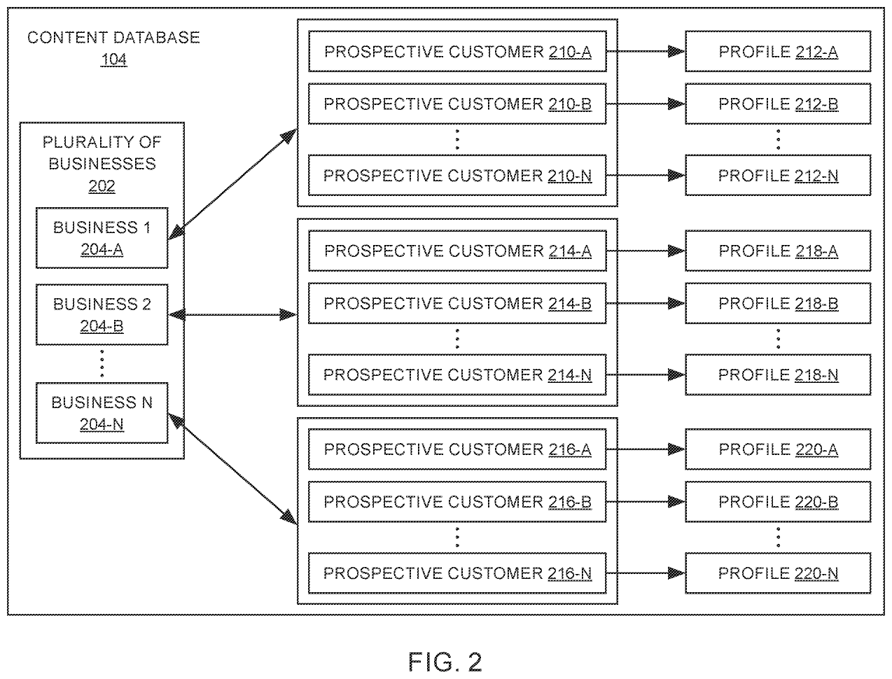

FIG. 2 is a schematic block diagram of a content database (104) of the system (100) of FIG. 1, according to an embodiment of the present invention. As shown, the content database (104) includes details of a plurality of businesses (202). Details of the plurality of business (202) can be stored in separate data blocks 204a-204n. Each business (204a) may have a plurality of prospective customers 210a-210n, as identified by the personalized sales agent (112). Further, each prospective customer (e.g. 210a) would have a profile (e.g. profile of prospective customer 1 (212a). For example, the profile (210a) would store the likes, dislikes, personal information, preferences of the prospective customer (210a). Similarly, business (204b) would have a list of prospective customers (214a-214n) and the profiles of the list of prospective customers (214a-214n) are stored as (218a-218n). Further, a list of prospective customers (216a-216n) of business (204n) would have profiles stored as (220a-220n).

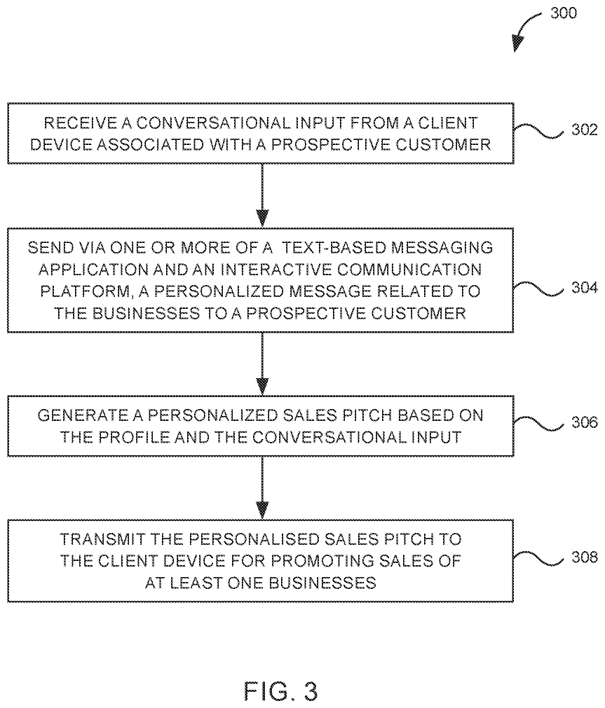

FIG. 3 is a flowchart (300) of a method for implementing a personalized sales agent for promoting sales of a business, according to some aspects of the present invention.

At 302, a conversational input from a client device associated with a prospective customer is received by a personalized sales agent via an interactive communication platform.

At 304, a profile associated with the prospective customer is identified from a content database that stores a plurality of profiles of prospective customers, and details of offerings provided by the plurality of businesses. The content database is updated at predefined time periods when the conversational input is received. Further, the preferences of each prospective customer are updated upon receiving one or more conversational inputs associated with the each prospective customer. The conversational inputs can be one or more of a text, message, email, chat, video and audio information.

At 306, a personalized sales pitch is generated based on the profile and the conversational input, where the personalized sales pitch matches the profile with one or more offerings provided by at least one business. Typically, a generic video is received from the content database along with a plurality of prospective customer related information as the conversational input. A product relevant to the prospective customer is identified based on the conversational input. Further, the genetic video is modified into the personalized video comprising a sales pitch for the product.

At 308, the personalized sales pitch is transmitted to the client device. The personalized sales pitch helps in promoting sales of the at least one business. A real-time personalized conversation between the personalized sales agent and the client deice is facilitated by the interactive communication platform.

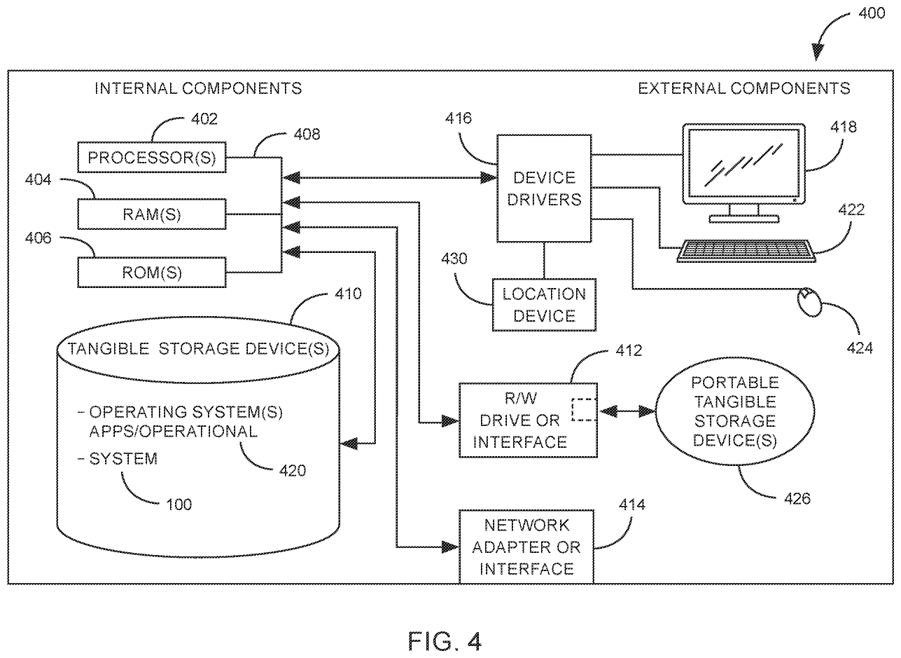

FIG. 4 is a block diagram of an embodiment of a computing device in which the modules of a system for implementing a personalized sales agent, described herein, are implemented. The modules of the system (100) for implementing a personalized sales agent, described herein are implemented in computing devices. One example of a computing device (400) is described below in FIG. 4. The computing device (400) includes one or more processor(s) (402), one or more computer-readable RAMs (404) and one or more computer-readable ROMs (406) on one or more buses (408). Further, computing device (400) includes a tangible storage device (410) that may be used to execute operating systems (420) and the system (100). The various modules of the online review system (100) may be stored in the tangible storage device (410). Both, the operating systems (420) and the online platform system (100) are executed by the one or more processor(s) (402) via one or more respective RAMs (404) (which typically include cache memory). The execution of the operating systems (420) and/or the online platform system (100) by the one or more processor(s) (402), configures the one or more processor(s) (402) as a special purpose processor configured to carry out the functionalities of the operation systems (420) and/or the system (100) as described above.

Examples of the tangible storage device (410) include semiconductor storage devices such as ROM, EPROM, flash memory or any other computer-readable tangible storage device that may store a computer program and digital information.

Computing device (400) also includes a R/W drive or interface (414) to read from and write to one or more portable computer-readable tangible storage devices (428) such as a CD-ROM, DVD, memory stick or semiconductor storage device. Further, network adapters or interfaces (412) such as a TCP/IP adapter cards, wireless Wi-Fi interface cards, or 3G or 4G wireless interface cards or other wired or wireless communication links are also included in computing device.

In one example embodiment, the system (100) may be stored in the tangible storage device (410) and may be downloaded from an external computer via a network (for example, the Internet, a local area network or other, wide area network) and network adapter or interface (412).

Computing device (400) further includes device drivers (416) to interface with input and output devices. The input and output devices may include a computer display monitor (418), a keyboard (422), a keypad, a touch screen, a computer mouse (424), and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, prospective customer applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

We claim:

1. A system comprising:
a memory comprising instructions; and
a processing device operatively coupled to the memory, the processing device to execute the instructions to:
receive by a personalized sales agent via an interactive communication platform a conversational input from a client device associated with a prospective customer, wherein the personalized sales agent is implemented by the processing device;
identify a profile associated with the prospective customer from a content database that stores plurality of profiles of prospective customers and offerings provided by plurality of businesses;
generate a personalized sales pitch based on the profile and the conversational input, wherein the personalized sales pitch matches the profile with one or more offerings provided by at least one business; and
transmit via the interactive communication platform the personalized sales pitch to the client device for promoting sales of the at least one business.

2. The system of claim 1, wherein the content database comprises curated data related to a plurality of businesses, products associated with each business, categories of prospective customers, and a plurality of prospective customers, and wherein the data related to the plurality of prospective customers comprises prospective customer profile information for each prospective customer and preferences of each prospective customer.

3. The system of claim 2, wherein the processor to:
update the content database at predefined time periods and when the conversational input is received; and
update the preferences of each prospective customer upon receiving one or more conversational inputs from each prospective customer.

4. The system of claim 1, wherein the conversational input comprises one or more of a text, message, email, chat, video and audio information, and wherein the conversational input is received during a plurality of time periods, when the prospective customer interacts with the personalized sales agent.

5. The system of claim 1, wherein the processing device to:
receive a generic video from the prospective customer along with a plurality of prospective customer related information as the conversational input;
identify a product as relevant to the prospective customer based on the conversational input; and
modify the generic video into the personalized video comprising a sales pitch for the product.

6. The system of claim 1, wherein the processing device to:
create a personalized landing page for a prospective customer visiting a website associated with at least one company that is selling the product.

7. The system of claim 1, wherein the processing device to facilitate real-time personalized conversation between the personalized sales agent and the prospective customer via the interactive communication platform.

8. A method comprising:
receiving by a personalized sales agent via an interactive communication platform a conversational input from a client device associated with a prospective customer, wherein the personalized sales agent is implemented by the processing device;
identifying a profile associated with the prospective customer from a content database that stores plurality of profiles of prospective customers and offerings provided by plurality of businesses;
generating a personalized sales pitch based on the profile and the conversational input, wherein the personalized sales pitch matches the profile with one or more offerings provided by at least one business; and
transmitting via the interactive communication platform the personalized sales pitch to the client device for promoting sales of the at least one business.

9. The method of claim 8, wherein the content database comprises curated data related to a plurality of businesses, products associated with each business, categories of prospective customers, and a plurality of prospective customers, and wherein the data related to the plurality of prospective customers comprises prospective customer profile information for each prospective customer and preferences of each prospective customer.

10. The method of claim 9, further comprising:
updating the content database at predefined time periods and when the conversational input is received; and
updating the preferences of each prospective customer upon receiving one or more conversational inputs from the each prospective customer.

11. The method of claim 8, wherein the conversational input comprises one or more of a text, message, email, chat, video and audio information, and wherein the conversational input is received during a plurality of time periods.

12. The method of claim 8, further comprising:
receiving a generic video from the content database along with a plurality of prospective customer related information as the conversational input;
identifying a product as relevant to the prospective customer based on the conversational input; and
modifying the generic video into the personalized video comprising a sales pitch for the product.

13. The method of claim 8, further comprising:
creating a personalized landing page for a prospective customer visiting a website associated with at least one company that is selling the product.

14. The method of claim 8, further comprising:
facilitating, via the interactive communication platform a real-time personalized conversation between the personalized sales agent and the client device.
